(19) United States
(12) Patent Application Publication
(10) Pub. No.: US 2022/0256898 A1
(43) Pub. Date: Aug. 18, 2022

(54) USE OF A DIPEPTIDE AS A SALTY TASTE ENHANCER

(71) Applicants: FUNDACIÓ EURECAT, CERDANYOLA DEL VALLES (ES); UNIVERSITAT ROVIRA I VIRGILI, TARRAGONA (ES)

(72) Inventors: Antoni CAIMARI PALOU, TARRAGONA (ES); Nadia ORTEGA OLIVE, SENTMENAT (ES); Luis Maria AROLA FERRER, TARRAGONA (ES); Josep Maria DEL BAS PRIOR, TARRAGONA (ES); Gerard PUJADAS ANGUIANO, ALTAFULLA (ES); Santiago GARCÍA VALLVÉ, TARRAGONA (ES)

(21) Appl. No.: 17/623,039

(22) PCT Filed: Jun. 26, 2020
(86) PCT No.: PCT/EP2020/067987

§ 371 Date: Dec. 27, 2021

(30) Foreign Application Priority Data
Jun. 28, 2019 (EP) 19382552.8

(51) Int. Cl. A23L 27/21; A23L 27/40; A23L 27/00

(52) U.S. Cl. CPC A23L 27/21; A23L 27/88; A23L 27/40

(57) ABSTRACT

The present invention relates to a use of a dipeptide comprising proline and alanine as salty taste enhancer in an edible article comprising salt, to an edible composition comprising the dipeptide proline-alanine, and to the edible article that comprises it. In addition, the invention also relates to a method for enhancing salty taste and reducing content of salt in food and beverages.

This application claims the benefit of European Patent Application EP19382552.8 filed on Jun. 28, 2019.

### TECHNICAL FIELD

The present invention belongs to the field of food and drink industry. In particular, it relates to the use of a dipeptide as a salty taste enhancer in foods or drinks, allowing the reduction of salt content. It also relates to edible compositions and edible articles containing the dipeptide.

### BACKGROUND ART

Sodium is an essential nutrient for normal physiological functions in human body; but, currently, the daily sodium intake exceeds the amount of 2 g of sodium/day recommended by the World Health Organization. High sodium consumption, which is ingested as common salt (NaCl), is directly related to cardiovascular diseases, such as hypertension, strokes, congestive heart failure, renal diseases, osteoporosis and kidney stones. Despite the recommendation of diminishing sodium intake, significant sodium reduction in foods is hampered because it results in less tasty products and increased bitterness.

Most sodium consumed comes from processed (cooked, canned, frozen, dehydrated, or milled) foods. Nowadays there is a strong demand from consumers for products that are convenient and quick to prepare in addition to being tasty and safe to eat. As a result, ready-meals have become increasingly popular with consumers in recent times.

In food industry, salt reduction can be achieved by using suitable salt replacers or taste enhancers. At industrial level the most widely used salt replacer is potassium chloride (KCl), but it has been shown to impart bitter and/or metallic notes to foods when used at high levels. Moreover, high intake of potassium has also bad health consequences as it can lead to hyperpotassemia due to its impact in potassium homeostasis. As salty taste enhancers, glutamate monosodium is widely used but its use can lead to sickness, hyperactivity and migraine.

Certain amino acids have also been reported as salty taste enhancers, such as L-lysine, arginine, a mixture of arginine and aspartate but presenting inconvenient off-flavors (Israr T et al. 2016) (Schindler A et al. 2011). Dipeptides containing non-natural and/or natural amino acids have also been disclosed as salty taste enhancers, for example, dipeptides comprising glycine (US2016374380); glutamic acid (US2011064861 and US2003091721), when combined to an enzymatic decomposition product of a protein material and/or a basic amino acid such as arginine (U.S. Pat. No. 8,409,653); and dipeptides containing arginine (Schindler A et al. 2011) (Xu J J et al. 2017).

Certain peptides have been used in order to provide tastes, for example sweet taste (JP2003104997) or bitter taste (GB1420909).

The finding of taste enhancers is difficult and unpredictable. Amino acids can interact with many receptors; the tastes of individual amino acids are complex and in human sensory studies have been described by more than one taste characteristic; moreover, there is no strict relationship between the taste of dipeptides and the constituent amino acids (Xu J J et al. 2017). Besides, currently, there is uncertainty about the true salty taste receptors, with the consequence that cell-based assays have not shown much success in the identification of salty taste enhancers (Schindler A et al. 2011). Moreover, the type of cell used can influence the result in cell-based assays (Xu J J et al. 2017).

Food choice crucially depends on taste quality. The content of salt directly determines sensory acceptance of savory foods, such as soups, sauces, dressings, ready-to-eat meals, and snacks, but also bakery products including bread, biscuits and cakes. There is an urgent need to salt reduction in food products while conserving the quality and taste.

### SUMMARY OF INVENTION

Surprisingly, the inventors have found a dipeptide comprising proline and alanine which enhances salty taste, without having organoleptic undesirable characteristics. Moreover, the dipeptide of the invention is easy to manipulate and therefore can be added to edible compositions or articles in food industry.

Performing standardized taste assessment trials the inventors have found that the dipeptide of the present invention is a salty taste potentiator. In a panel test, salty taste for a proline-alanine (PA) dipeptide dissolved in water was identified by the panelists (example 1) and in comparison with a known salty taste enhancer dipeptide, the dipeptide PA of the invention presented less after taste than the known salt enhancer (example 2). In a food matrix, using broth as an example, the dipeptide PA was found to enhance salty taste and presented less after taste than when dissolved in water (example 3).

Adding the salty taste enhancer of the present invention to a common salt-containing food, feed or beverage, has the effect of enhancing the salty taste derived from common salt contained in the food. Thus, by using the salty taste enhancer of the present invention, even if the quantity of common salt in a food item is low, it is possible to produce an edible product with salty taste. Thus, using the dipeptide comprising proline and alanine it is possible to reduce the quantity of common salt used in edible articles.

Thus, a first aspect of the invention refers to the use of a dipeptide comprising proline and alanine as a salty taste enhancer in an edible article comprising a salt.

A second aspect of the invention refers to an edible composition comprising the dipeptide proline-alanine and one or more appropriate edible acceptable excipients or carriers.

The salty taste enhancer of the present invention does not have a taste that restricts it use in certain foods, and, therefore, it can be used in a wide variety of foods, feed and beverages.

A third aspect of the invention refers to an edible article comprising the edible composition of the second aspect of the invention, and a foodstuff base comprising a salt.

A fourth aspect of the invention refers to a method to enhance salty taste of an edible article comprising a salt, wherein the method comprises the addition of a dipeptide comprising proline and alanine or, alternatively, the edible composition of the second aspect of the invention, to the edible article.

### BRIEF DESCRIPTION OF DRAWINGS

FIG. 1 shows the intensity of salty taste that the judges attributed to each of the samples presented with reference to a given scale (44.5-140.3 mM NaCl).

### DETAILED DESCRIPTION OF THE INVENTION

The first aspect of the invention refers to the use of a dipeptide comprising proline and alanine as a salty taste enhancer in an edible article comprising a salt.

An embodiment of the first aspect of the invention, optionally in combination with any of the embodiments provided below, refers to the use of the dipeptide Proline-Alanine as a salty taste enhancer in an edible article comprising a salt.

In this embodiment of the first aspect of the invention, the carboxyl group of the proline (also known by the expert as Pro in three letter code and as “P” in the one letter code) is bound by a peptide bond to the amino group of the alanine (also known by the expert as Ala in three letter code and as “A” in the one letter code), forming the proline-alanine dipeptide, also known as “Pro-Ala”, or “PA” dipeptide.

Another embodiment of the first aspect of the invention, optionally in combination with any of the embodiments provided above or below, refers to the use of the dipeptide Alanine-Proline as a salty taste enhancer in an edible article comprising a salt.

In this embodiment of the first aspect of the invention, the carboxyl group of the alanine is bound by a peptide bond to the amino group of the proline, forming the alanine-proline dipeptide, also known as “Ala-Pro”, or “AP” dipeptide.

In an embodiment of the first aspect of the invention, optionally in combination with any of the embodiments provided above or below, the amino acids Ala and/or Pro are L-amino acids.

In an embodiment of the first aspect of the invention, optionally in combination with any of the embodiments provided above or below, the dipeptide is Pro-Ala and the amino acids are L-amino acids.

In an embodiment of the first aspect of the invention, optionally in combination with any of the embodiments provided above or below, the dipeptide is a linear dipeptide.

In an embodiment of the first aspect of the invention, optionally in combination with any of the embodiments provided above or below, the dipeptide is Pro-Ala and is a linear dipeptide.

In an embodiment of the first aspect of the invention, optionally in combination with any of the embodiments provided above or below, the dipeptide is Pro-Ala, is a linear dipeptide and the amino acids are L-amino acids.

In another embodiment of the first aspect of the invention, the dipeptide is a synthetic dipeptide. The method of synthesis of the dipeptide of the present invention are known by the expert in the field, for example in Yagasaki M et al. 2008.

In another embodiment of the first aspect of the invention, the dipeptide is a dipeptide obtained from organic material, for example, is a by-product of a co-product of vegetal or animal origin, for example, obtained by enzymatic hydrolysis of organic material.

The term “taste enhancer” (or “taste potentiator”) refers to any substance, compound or ingredient which is capable of increasing the taste and aroma perception of tastants (which are the compounds that elicit taste) in an edible article comprising a salt, wherein the taste enhance has no such taste of its own. Therefore, the taste enhancer increases flavor (which includes taste and aroma).

The term “salty taste enhancer” refers to any substance, compound or ingredient which increases the perception of saltness, increasing the salty taste in an edible article comprising a salt. The salty taste enhancer increases salty flavor.

Taste assessment can be performed following the principles of the International Organization for Standardization (ISO). For example, performing taste assessment trials.

Taste assessment trials (named also as sensory tests, taste panel studies or gustatory sensation tests) are conventional physiological or psychophysical evaluation of tastants involving estimation of gustatory sensation responses in healthy human volunteers within well controlled procedures. The taste assessment trials performed in the present invention were performed following expert criteria. For example, sensory tests can be performed by following the methods described in Schindler A et al. 2011 J. Agric. Food Chem. 59:12578-12588.

The term “edible” refers to ingredients including the dipeptide of the present invention, compositions or articles that may be consumed by humans without significant deleterious health consequences.

In another embodiment of the first aspect of the invention, optionally in combination with any of the embodiments provided above or below, the edible article is a low salt edible article.

The terms “low salt” or “low sodium” are terms recognized by the expert. For example the “Regulation (EC) 1924/2006 of the European Parliament and of the Council of 20 Dec. 2006 on Nutrition and Health claims made on foods” stablished that a food with “low sodium/salt” is the edible product that contains no more than 0.12 g of sodium, or the equivalent value for salt, per 100 g or per 100 mL; a “very low sodium/salt” product is the product that contains no more than 0.04 g of sodium, or the equivalent value for salt, per 100 g or per 100 mL; whereas the term “sodium-free or salt-free”, refers, to the food product which contains no more than 0.005 g of sodium, or the equivalent value for salt, per 100 g.

For waters to be considered “low salt/sodium”, other than natural mineral waters falling within the scope of Directive 80/777/EEC, according to the Regulation 1924/2006 of the European Parliament and of the Council of 20 Dec. 2006, this value should not exceed 2 mg of sodium per 100 ml.

Thus, in an embodiment of the first aspect of the invention, optionally in combination with any of the embodiments provided above or below, the salt content (for example, sodium) in the edible article is equal to or less than 0.120 g/100 mg or 0.120 g/100 ml.

Thus, in an embodiment of the first aspect of the invention, optionally in combination with any of the embodiments provided above or below, the salt content (for example, sodium) in the edible article is equal to or less than 0.04 g/100 mg or 0.04 g/100 ml.

Thus, in an embodiment of the first aspect of the invention, optionally in combination with any of the embodiments provided above or below, the salt content (for example, sodium) in the edible article is equal to or less than 0.005 g/100 g,

In an embodiment of the first aspect of the invention, optionally in combination with any of the embodiments provided above or below, the edible article has a reduced content in salt; in a particular embodiment, it has a reduced content in salt in comparison with the conventional edible article.

The conventional edible article refers to the edible article with its normal content of salt, or to the edible article which its content of salt has not been altered.

In an embodiment of the first aspect of the invention, optionally in combination with any of the embodiments provided above or below, the salt is selected from sodium chloride, potassium chloride, calcium chloride and any combination thereof.

In an embodiment of the first aspect of the invention, optionally in combination with any of the embodiments provided above or below, the salt is sodium chloride.

In an embodiment of the first aspect of the invention, optionally in combination with any of the embodiments provided above or below, in the edible article having a reduced content in salt, the salt content has been reduced in an amount from 1% to 99% in weight with respect to the weight of the original edible article comprising salt.

In an embodiment of the first aspect of the invention, optionally in combination with any of the embodiments provided above or below, the reduction of the amount of salt, for example, sodium chloride, is of at least a 0.1%, 0.5%, 1%, 2%, 5%, 10%, 15%, 20%, 25%, 30%, 35%, 40%, 50%, 55%, 60%, 70%, 75%, 80%, 85%, 90%, or a 99%.

The quantity of salty taste enhancer added depends on the type of edible article and can be adjusted by the expert in the field, for example, by performing sensory evaluation.

In an embodiment of the first aspect of the invention, optionally in combination with any of the embodiments provided above or below, the dipeptide is added to the edible article comprising salt in an amount from 0.1% to 15% by weight with respect to the weight of the edible article.

In an embodiment of the first aspect of the invention, optionally in combination with any of the embodiments provided above or below, the dipeptide is added to the edible article comprising salt in an amount from 0.1% to 15% by weight with respect to the weight of the edible article; for the reduction of the amount of salt, for example, sodium chloride, of 0.1%-25%.

In an embodiment of the first aspect of the invention, optionally in combination with any of the embodiments provided above or below, the dipeptide, for example the Pro-Ala dipeptide is a 0.01% to 15% by weight with respect to the weight of the edible article; for example, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, or 15%.

In an embodiment of the first aspect of the invention, optionally in combination with any of the embodiments provided above or below, the dipeptide, for example the Pro-Ala dipeptide, is used in a concentration of 0.01 mM, 0.02 mM, 0.03 mM, 0.04 mM, 0.05 mM, 0.06 mM, 0.07 mM, 0.08 mM, 0.09 mM, 0.1 mM, 0.2 mM, 0.3 mM, 0.4 mM, 0.5 mM, 0.6 mM, 0.7 mM, 0.8 mM, 0.9 mM, 1 mM, 2 mM, 3 mM, 4 mM, 5 mM, 6 mM, 7 mM, 8 mM, 9 mM, 10 mM, 11 mM, 12 mM, 13 mM, 14 mM, or 15 mM.

In an embodiment of the first aspect of the invention, optionally in combination with any of the embodiments provided above or below, the enhancement provided by the salty taste enhancer is quantified by a sensory evaluation, for example by trained judges ranking a sample comprising the dipeptide of the invention, in comparison with control samples comprising a range of known salt concentration, based on the intensity of salty taste perception.

The second aspect of the invention refers to an edible composition (edible additive) comprising the dipeptide proline-alanine and one or more appropriate edible acceptable excipients or carriers.

The term “edible acceptable excipients or carriers” refers to excipients or carriers which are substantially neutral from a flavor point of view, insofar as it does not significantly alter the organoleptic properties of flavoring ingredients. Further, they are suitable for use in the preparation of compositions which can be consumed by humans without significant deleterious health consequences.

For, example, the edible composition of the second aspect of the invention can comprises colorants and/or light resistance agents.

In an embodiment of the second aspect of the invention, optionally in combination with any of the embodiments provided above or below, the edible composition comprises a natural extract, for example of vegetal or animal origin, which comprises the dipeptide as defined in the first aspect of the invention.

In an embodiment of the second aspect of the invention, optionally in combination with any of the embodiments provided above or below, the edible composition in addition comprises one or more another flavor compound.

In an embodiment of the second aspect of the invention, optionally in combination with any of the embodiments provided above or below, the edible composition in addition comprises a salt selected from sodium chloride potassium chloride, calcium chloride and any combination thereof.

In an embodiment of the second aspect of the invention, optionally in combination with any of the embodiments provided above or below, the edible composition in addition comprises sodium chloride.

In an embodiment of the second aspect of the invention, optionally in combination with any of the embodiments provided above or below, the edible composition can be formulated in several forms that include, but are not limited to, solid or liquid forms.

The edible compositions of the present invention can be prepared according to methods well known in the state of the art. The appropriate edible acceptable excipients and/or carriers, and their amounts, can readily be determined by those skilled in the art according to the type of compositions being prepared.

The edible composition is an edible additive that can be added to edible articles.

Thus, a third aspect of the invention refers to an edible article comprising the edible composition of the second aspect of the invention, and a foodstuff base comprising a salt.

The term “foodstuff base” refers to an edible product for instance a human being food, an animal food (i.e. feed) or a beverage that has one or more salts (salty taste compounds).

In an embodiment of the third aspect of the invention, optionally in combination with any of the embodiments provided above or below, the edible article is one wherein the foodstuff base is a human being food.

Suitable foodstuff bases can be fried or not, frozen or not, low fat or not, marinated, battered, chilled, dehydrated, instant, canned, reconstituted, retorted or preserved product. Examples of foodstuffs for the present invention include, without limitation: a seasoning or condiment, such as a stock, a savory cube, a concentrate, a powder mix, a flavored oil, a sauce (for example, tomato ketchup, soy sauce, mustard, mayonnaise), or a salad dressing; a dairy or fat product, such as a cheese, a spread, a regular or low-fat margarine, a butter/margarine blend, a butter, a peanut butter, a shortening, a processed and flavored cheese; a broth (for example, chicken broth), a soup, such as a clear soup, a cream soup, a chicken or beef soup or a tomato or asparagus soup; a savory product, such as a snack or appetizer, chips (such as potato chips) or crisps popcorn, nuts, a biscuit, seeds, or pickles; a meat-based product, such as a poultry, beef or pork based product (for example, sausages, hamburgers, nuggets); a fish-based product or seafood-based product, such as, surimi, or a fish sausage, fish-hamburger; an egg-product; a carbohydrate-based product, such as pizza, instant noodles, pasta, potatoes flakes or fried, noodles, tortillas or wraps, rice, rice-based foods, for example, a rice cake, or a rice cracker; an imitation products, such as a dairy (e.g a reformed cheese made from oils, fats and thickeners) or seafood or meat analogue (e.g. a vegetarian meat replacer, veggie burgers); a baked product, such as bread, cookies, cakes, and bretzel; prepared foods such as pies, spring rolls, dumplings, curries, stews, fried foods, or processed livestock products; among others.

In an embodiment of the third aspect of the invention, optionally in combination with any of the embodiments provided above or below, the edible article is one wherein the foodstuff base is an animal food (feed), such as fodder and forage.

In an embodiment of the third aspect of the invention, optionally in combination with any of the embodiments provided above or below, the edible article is one wherein the foodstuff base is a beverage, e.g. water, juices, or sodas.

In an embodiment of the third aspect of the invention, optionally in combination with any of the embodiments provided above or below, the salt comprised in the foodstuff base is selected from the list consisting of: sodium chloride, potassium chloride, calcium chloride and any combination thereof.

In an embodiment of the third aspect of the invention, optionally in combination with any of the embodiments provided above or below, the salt comprised in the foodstuff base is sodium chloride.

In an embodiment of the first or the third aspect of the invention, optionally in combination with any of the embodiments provided above or below, the edible article is a food, feed or beverage.

In an embodiment of the first or the third aspect of the invention, optionally in combination with any of the embodiments provided above or below, the edible article is a human being food.

In an embodiment of the first or the third aspect of the invention, optionally in combination with any of the embodiments provided above or below, the edible article is selected from the list consisting of: a seasoning or condiment, a dairy or fat product, a broth, a soup, a savory product, a meat-based product, a seafood-based product, a fish-based product, an egg-based product, a carbohydrate-based product, a baked product, an imitation food products.

In an embodiment of the first or third aspect of the invention, optionally in combination with any of the embodiments provided above or below, the edible article, is selected from: a seasoning or condiment, such as a stock, a savory cube, a concentrate, a powder mix, a flavored oil, a sauce (for example, tomato ketchup, soy sauce, mustard, mayonnaise), or a salad dressing; a dairy or fat product, such as a cheese, a spread, a regular or low-fat margarine, a butter/margarine blend, a butter, a peanut butter, a shortening, a processed and flavored cheese; a broth, a soup, such as a clear soup, a cream soup, a chicken or beef soup or a tomato or asparagus soup; a savory product, such as a snack or appetizer, chips (such as potato chips) or crisps popcorn, nuts, a biscuit, seeds, or pickles; a meat-based product, such as a poultry, beef or pork based product (for example, sausages, hamburgers, nuggets); a fish-based product or seafood-based product, such as, surimi, or a fish sausage, fish-hamburger; an egg-product; a carbohydrate-based product, such as pizza, instant noodles, pasta, potatoes flakes or fried, noodles, tortillas or wraps, rice, rice-based foods, for example, a rice cake, or a rice cracker; an imitation products, such as a dairy (e.g a reformed cheese made from oils, fats and thickeners) or seafood or meat analogue (e.g. a vegetarian meat replacer, veggie burgers); a baked product, such as bread, cookies, cakes, and bretzel; prepared foods such as pies, spring rolls, dumplings, curries, stews, fried foods, and processed livestock products.

In another embodiment of the first or third aspect of the invention, optionally in combination with any of the embodiments provided above or below, the edible article is packed, canned, frozen, dehydrated, milled or processed.

In an embodiment of the first or the third aspect of the invention, optionally in combination with any of the embodiments provided above or below, the edible article is an animal food (feed) such as fodder and forage.

In an embodiment of the first or the third aspect of the invention, optionally in combination with any of the embodiments provided above or below, the edible article is a beverage, for example, water, juices, or sodas.

In another embodiment of the third aspect of the invention, optionally in combination with any of the embodiments provided above or below, the edible article comprises the dipeptide in a 0.1% to 15% in weight as defined in the first aspect of the invention; in an example, it comprises the dipeptide in a 0.1-10%; or, alternatively, in a 0.1-5%; or, alternatively, in a 0.1-2.5% in weight.

In another embodiment of the third aspect of the invention, optionally in combination with any of the embodiments provided above or below, the edible article comprises the dipeptide in at least a 0.01% to 15% in weight with respect to the weight of the edible article, for example, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, or 15%.

In another embodiment of the third aspect of the invention, optionally in combination with any of the embodiments provided above or below, the edible article comprises 0.01 mM, 0.02 mM, 0.03 mM, 0.04 mM, 0.05 mM, 0.06 mM, 0.07 mM, 0.08 mM, 0.09 mM, 0.1 mM, 0.2 mM, 0.3 mM, 0.4 mM, 0.5 mM, 0.6 mM, 0.7 mM, 0.8 mM, 0.9 mM, 1 mM, 2 mM, 3 mM, 4 mM, 5 mM, 6 mM, 7 mM, 8 mM, 9 mM, 10 mM, 11 mM, 12 mM, 13 mM, 14 mM, or 15 mM.

In another embodiment of the third aspect of the invention, optionally in combination with any of the embodiments provided above or below, the edible article is a liquid food, for example a broth or a beverage, comprises 0.1 mM to 30 mM of the dipeptide as defined in the first aspect of the invention; in an example, it comprises 5 mM to 20 mM, in yet another example, it comprises 8 mM to 12 mM, or, alternatively, it comprises 0.01 mM to 1 mM, for example 0.01 mM, 0.02 mM, 0.03 mM, 0.04 mM, 0.05 mM, 0.06 mM, 0.07 mM, 0.08 mM, 0.09 mM, 0.1 mM, 0.2 mM, 0.3 mM, 0.4 mM, 0.5 mM, 0.6 mM, 0.7 mM, 0.8 mM, 0.9 mM, 1 mM, 2 mM, 3 mM, 4 mM, 5 mM, 6 mM, 7 mM, 8 mM, 9 mM, 10 mM, 11 mM, 12 mM, 13 mM, 14 mM, or 15 mM.

In another embodiment of the third aspect of the invention, optionally in combination with any of the embodiments provided above or below, the edible article is a “low salt” or a “low sodium” edible article.

In another embodiment of the third aspect of the invention, optionally in combination with any of the embodiments provided above or below, the salt content (for example, sodium) in the edible article is equal to or less than 0.120 g/100 mg or 0.120 g/100 ml.

In another embodiment of the third aspect of the invention, optionally in combination with any of the embodiments provided above or below, the edible article is a “very low salt” or a “very low sodium” edible article.

Thus, in an embodiment of the third aspect of the invention, optionally in combination with any of the embodiments provided above or below, the salt content (for example, sodium) in the edible article is equal to or less than 0.04 g/100 mg or 0.04 g/100 ml.

Thus, in an embodiment of the third aspect of the invention, optionally in combination with any of the embodiments provided above or below, the salt content (for example, sodium) in the edible article is equal to or less than 0.005 g/100 g.

In an embodiment of the third aspect of the invention, optionally in combination with any of the embodiments provided above or below, the beverage is water and the salt content (for example, sodium) is less than 2 mg of salt/100 ml.

In another embodiment of the third aspect of the invention, optionally in combination with any of the embodiments provided above or below, in the edible article the common salt-content is lower than in conventional foods or drinks.

In another embodiment of the third aspect of the invention, optionally in combination with any of the embodiments provided above or below, the edible article contains a reduced content in salt, preferably sodium chloride, of at least 1% to 99%. In an example, of at least a 0.1%, 0.5%, 1%, 2%, 5%, 10%, 15%, 20%, 25%, 30%, 35%, 40%, 50%, 55%, 60%, 70%, 75%, 80%, 85%, 90%, or a 99%.

In another embodiment of the third aspect of the invention, optionally in combination with any of the embodiments provided above or below, the edible article contains a reduced content of sodium chloride of 0.1 to 50%, in an example of 0.1-30%, in another example of 0.1-25%, in another example of 0.1-15%.

In another embodiment of the third aspect of the invention, optionally in combination with any of the embodiments provided above or below, the edible article is a broth. In an example, the broth contains a reduced content of sodium chloride of 10-45%, in an example of 20-30%.

In another embodiment of the third aspect of the invention, optionally in combination with any of the embodiments provided above or below, in the edible article the reduction in salt is in comparison with the original or conventional edible article with sodium chloride and which does not contain the edible composition as defined in the second aspect of the invention. In an example, the edible article of the third aspect of the invention has the same salty taste as the original or conventional edible article, for example, by performing sensory evaluation tests; for example, by performing the sensory test described in Schindler A et al. 2011)

In another embodiment of the third aspect of the invention, optionally in combination with any of the embodiments provided above or below, the edible article is a broth and comprises the dipeptide proline-alanine in an amount of 0.10 g/100 mL to 0.50 g/100 mL, in another example of 0.14 g/100 mL to 0.30 g/100 mL, in another example of 0.20 g/100 mL to 0.30 g/100 mL, in yet another example of 0.22 g/100 mL; and a content of sodium chloride of 0.10 g/100 mL to 0.50 g/100 mL, in another example of 0.20 g/100 mL to 0.30 g/100 mL, in yet another example of 0.26 g/100 mL.

In another embodiment of the third aspect of the invention, optionally in combination with any of the embodiments provided above or below, the edible article is a broth and comprises the dipeptide proline-alanine in an amount of 0.14 g/100 mL or, alternatively, 0.22 g/100 mL; and a content of sodium chloride of 0.26 g/100 mL.

In another embodiment of the third aspect of the invention, optionally in combination with any of the embodiments provided above or below, in the edible article the foodstuff base in addition comprises at least another flavor compound.

In another embodiment, optionally in combination with any of the embodiments provided above or below, in the edible composition of the second aspect of the invention, or, alternatively, in the edible article of the third aspect of the invention, the additional flavor compound is selected form: a sweet taste compound, a bitter taste compound, a sour taste compound, an UMAMI taste compound, a KOKUMI taste compound, a savoury and mouthfulness imparting flavor compounds, a sweet imparting flavor compounds, a sour imparting flavor compound, a bitter imparting flavor compound, and any combinations thereof.

In another embodiment, optionally in combination with any of the embodiments provided above or below, in the edible composition of the second aspect of the invention, or, alternatively, in the edible article of the third aspect of the invention, the another taste compound is an UMAMI taste compound or a KOKUMI taste compound; and wherein the flavor compound is a salty imparting flavor compounds and a savoury and mouthfulness imparting flavor compounds.

The edible article of the present invention can be prepared according to methods well known in the state of the art. The appropriate ingredients and processes for the preparation of the edible articles can readily be determined by those skilled in the art according to the type of edible article being prepared.

All the embodiments of the edible article of the third aspect of the invention are also embodiments of the first, second and fourth aspects of the invention.

A fourth aspect of the invention refers to a method to enhance salty taste of an edible article comprising a salt, wherein the method comprises the addition of a dipeptide comprising proline and alanine or, alternatively, the edible composition of the second aspect of the invention, to the edible article.

All the embodiments of the first, second and third aspects of the invention are also embodiments of the fourth aspect of the invention.

In an embodiment of the fourth aspect of the invention, optionally in combination with any of the embodiments provided above or below, the dipeptide is the proline-alanine dipeptide.

In an embodiment of the fourth aspect of the invention, optionally in combination with any of the embodiments provided above or below, the salt is sodium chloride.

An embodiment of the fourth aspect of the invention, optionally in combination with any of the embodiments provided above or below, the method is for reducing the amount of sodium chloride in an edible article without reducing saltiness of said edible article, preferably the reduction of the amount of sodium chloride is of at least a 0.1%, 0.5%, 1%, 2%, 5%, 10%, 15%, 20%, 25%, 30%, 35%, 40%, 50%, 55%, 60%, 70%, 75%, 80%, 85%, 90%, or a 99%.

In embodiment of the fourth aspect of the invention, optionally in combination with any of the embodiments provided above or below, the edible article is a “low salt”, “low sodium”, “very low salt”, or “very low sodium” edible article.

In an embodiment of the fourth aspect of the invention, optionally in combination with any of the embodiments provided above or below, the addition of the dipeptide comprising proline and alanine (for example, the proline-alanine dipeptide) or, alternatively, of the edible composition of the second aspect of the invention, is performed during the elaboration of the edible article; or, alternatively, after the elaboration of the edible article.

In an embodiment of the fourth aspect of the invention, optionally in combination with any of the embodiments provided above or below, the method comprises the following steps:
(a) obtaining a dipeptide comprising proline and alanine, preferably the dipeptide proline-alanine as defined in the first aspect of the invention; or, alternatively, obtaining an edible composition as defined in the second aspect of the invention;
(b) selecting as food material at least one foodstuff base; and
(c) adding the dipeptide obtained in step (a) or, alternatively, the edible composition of step (a), in an amount necessary to maintain saltiness, to the food material of step (b) in order to produce a salty taste low salt or low sodium edible article.

In an embodiment of the fourth aspect of the invention, optionally in combination with any of the embodiments provided above or below, the method comprises the following steps:
a. providing the salty taste enhancer dipeptide salty taste enhancer of the first aspect of the invention, or the composition of the second aspect of the invention;
b. selecting at least one food material (at least one foodstuff base); and
c. adding the salty taste enhancer dipeptide or, alternatively, the edible composition of step (a), in an amount necessary to maintain saltiness, to the food material of step (b) in order to produce a salty taste low salt or low sodium edible article; and
d. optionally, elaborating the edible article.

The elaboration of the edible article includes, for example, boiling, frying, cooking, baking, or steaming.

For example, in step (c) the dipeptide (for example Proline-alanine) is added to be in a percentage by weight with respect to the edible article of at least 0.01% to 15%, for example, 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, or 15%.

In an embodiment of the fourth aspect of the invention, optionally in combination with any of the embodiments provided above or below, the edible article is a low salt, or low sodium broth.

In an embodiment of the fourth aspect of the invention, optionally in combination with any of the embodiments provided above or below, the edible article is a broth with a content of sodium chloride of 0.26 g/100 mL; or, alternatively, of less than 0.120 g/100 mL.

In an embodiment of the fourth aspect of the invention, optionally in combination with any of the embodiments provided above or below, the edible article is a broth with a content of sodium chloride of 0.26 g/100 mL; or, alternatively, of less than 0.120 g/100 mL; and it contains from 0.10 g of the dipeptide/100 mL to 0.40 g of the dipeptide/100 mL; in an example, it contains 0.22 g of the dipeptide/100 mL.

In an embodiment of the fourth aspect of the invention, optionally in combination with any of the embodiments provided above or below, the method is a method to enhance salty taste of a broth comprising a salt (for example, with a content of sodium chloride of equal or less than 0.26 g/100 mL), wherein the method comprises the addition of the dipeptide proline-alanine, or, alternatively, the edible composition of the second aspect of the invention comprising the dipeptide proline-alanine, during the elaboration of the broth. For example, the broth is a chicken broth.

In an embodiment of the fourth aspect of the invention, in step (a) the dipeptide is obtained by enzymatic hydrolysis of an organic material. For example, from a by-product of a co-product of vegetal or animal origin.

In another embodiment of the fourth aspect of the invention, in step (a) the dipeptide is obtained by chemical synthesis, chemoenzymatic synthesis or enzymatic synthesis. The method of synthesis of the dipeptide of the present invention are known by the expert in the field, for example in Yagasaki M et al. 2008.

In another embodiment of the first and fourth aspect of the invention wherein the enhancement in salty taste comprises an increase in saltiness aftertaste.

The present invention also refers to the edible article obtainable by the method of the fourth aspect of the invention.

The term “obtainable by” is used herein for defining the edible article of the invention by its preparation process and refers to the products that can be obtained through the preparation process which comprise the indicated steps as herein defined.

For the purposes of the invention, the expressions “obtainable”, “obtained” and similar equivalent expressions are used interchangeably and, in any case, the expression “obtainable” encompasses the expression “obtained”.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples and drawings are provided by way of illustration, and they are not intended to be limiting of the present invention. Reference signs related to drawings and placed in parentheses in a claim, are solely for attempting to increase the intelligibility of the claim, and shall not be construed as limiting the scope of the claim. Furthermore, the present invention covers all possible combinations of particular and preferred embodiments described herein.

### EXAMPLES

1. First Sensorial Study:

A tasting panel was carried out with the dipeptide Proline-Alanine in order to elucidate whether it was a potentiator of salty taste.

a)—Ranking of a Series of Salt Solutions:

Materials and Methods:

Prior to the test of the dipeptide, a test was performed with seven volunteers (male and females with ages comprised between 25-45 years) to see if they were able to order from a minor to a greater concentration a series of solutions of salt, of 30, 40, 50, 60, 70 and 80 mM of NaCl. Subsequently, it was predicted the salt concentration of a solution (50 mM NaCl), comparing it with the series of solutions described above. To do this, the six solutions of salt (commercial salt “sal marina clásica” form “SAL COSTA”; composition: sea salt, anti-caking agent E-536 (potassium ferrocyanide) were prepared in bottled water of low mineralization (Bezoya) between 30 and 80 mM of NaCl (considering as if the salt was 100% NaCl) (by weighting the salt and dissolving it in the water). The volunteers were asked to order the solutions from lowest to highest salty taste, without knowing the concentration of salt of each solution.

Results:

TABLE 1
Order in which they were predicted from minor
to major salty taste a series of salt solutions

| | [NaCl] mM | | | | | |
|---|---|---|---|---|---|---|
| | 30 | 40 | 50 | 60 | 70 | 80 |
| | g salt in 100 ml of bottled water | | | | | |
| | 0.175 | 0.234 | 0.292 | 0.350 | 0.409 | 0.467 |
| Volunteer 1 | 1 | 2 | 3 | 6 | 5 | 4 |
| Volunteer 2 | 1 | 2 | 4 | 3 | 6 | 5 |
| Volunteer 3 | 1 | 3 | 2 | 4 | 5 | 6 |
| Volunteer 4 | 1 | 2 | 3 | 4 | 5 | 6 |
| Volunteer 5 | 1 | 2 | 3 | 4 | 5 | 6 |
| Volunteer 6 | 1 | 2 | 3 | 5 | 6 | 4 |
| Volunteer 7 | 1 | 2 | 3 | 4 | 5 | 6 |

As it can be seen in Table 1 three people did it perfectly and the others ordered the solutions reasonably well.

b)—Assessment of a Problem Sample:

Materials and Methods:

Next it was prepared a solution of salt equivalent to 50 mM NaCl (the “problem sample”) (prepared as in example 1a) Seven volunteers, without knowing the concentration of salt of the problem sample but having the above series of solutions of salt ordered from minor to greater concentration (of example 1a, see table 1), were asked to indicate to what solution of salt resembled more the salty taste of the problem sample.

Results:

Four volunteers said that the problem solution had a salty taste equivalent to a salt solution between salt solutions equivalent to 40 and 50 mM of NaCl (it was considered that these people predicted a salty taste equivalent to a solution of 45 mM NaCl), two volunteers said that the problem sample had the same salty taste as the salt solution equivalent to 50 mM NaCl, and one volunteer considered that the problem sample had the same salty taste as the solution of salt equivalent to 60 mM NaCl. Therefore, the average and standard deviation of the salt intensity perceived for the problem sample was 48.57 mM±5.56.

c)—Tasting Panel with the Dipeptide of the Present Invention:

Materials and Methods:

In order to confirm the salty taste enhancer property of the dipeptide of the present invention, it was prepared a solution of 12 mM of the dipeptide, which also contained salt, equivalent to a 110 mM NaCl solution (first, it was weighed the dipeptide and dissolved it in Bezoya bottled water; this solution was added to a solution with NaCl in bottled water; and finally, the volume of water needed was added to obtain the needed NaCl concentration).

The Pro-Ala (PA) dipeptide (with a purity of more than 99%) was purchased at Phoenix Pharmaceuticals, Inc. (Lot No 432688). The dipeptide Pro-Ala was a linear dipeptide.

The 7 volunteers tested and compared the salty taste of this solution with a series of salt solutions sorted from lowest to highest concentration (80, 90, 100, 110, 120, 130, 140 mM of NaCl) (prepared similarly as indicated in example 1a). They did the same with a salt solution equivalent to 110 mM of NaCl, which did not contain the dipeptide. The solutions were prepared using bottled water of low mineralization (Bezoya).

The taste of a 12 mM solution of the dipeptide without salt (dissolved in the low mineralization water, Bezoya) was also tested.

The experimental procedure to test whether the PA dipeptide was a salty taste enhancer, was based on the article of Schindler et al. 2011 (the methodology described in the article of Schindler et al. 2011 was also used in the scaling tests performed in the experiments below).

Results:

All volunteers observed a salty taste of the solution that had the dipeptide, with respect to the solution with the same amount of salt but that did not have the dipeptide. Two of the seven people found that the solution containing the dipeptide had an additional taste to the salty taste, in some cases not very pleasant. The mean and deviation of the salt concentration perceived for the 110 mM salt solution without the dipeptide was 103.57 mM±8.02; and for the solution of 110 mM with the dipeptide was 123.57 mM±9.45. Significantly different values: p=0.0011 (test t-student) and p=0.0023 (Mann-Whitney test) showed statistically differences.

Related to the taste of the 12 mM solution of the dipeptide without salt, none of the volunteers found the solution as salty.

2. Comparative Sensorial Study of the Salty Taste Enhancer Capacity of the Dipeptide

A comparison of the salty taste enhancement effect of the PA dipeptide was compared with the effect that it had with a peptide was already known to potentiate salty taste, the dipeptide proline-glycine (PG)

Material and Methods:

Selection of Judges:

This second study was done with 24 people (male and females with ages comprised between 25-45 years) in order to select for subsequent tests 12 judges (panelists) who had a good ability to recognize the salty taste and its intensity.

a)—Trial a The objective of this test was to determine if 24 volunteers were able to correctly sort out 6 solutions of growing salt concentration (30-80 mmol/L) (the salt solutions were prepared as in example 1a). The volunteers had to taste each sample and order them according to the perceived salt intensity. The judges could taste more than once the samples if they considered it necessary. The volunteer had to order the samples on the given scale obligatorily.

Fifteen of the twenty-four volunteers ordered the ladder well in increasing order.

b)—Trial b: Triangular Test

Three samples (NaCl concentrations of known concentration, two equal and one different, prepared similarly as in example 1) were presented to each of the 24 volunteers, one marked with R (50 mM NaCl) and two coded samples (“A”, 50 mM NaCl; and “B”, 60 mM NaCl). They had to taste the R followed by the two samples coded in a given order (the same order was not presented to the 24 tasters to avoid any influence; different combinations were presented). Volunteers had to identify the sample that was different from R. They could try more than once the samples if they considered it necessary. They had to choose one of the two options that were provided.

Twenty of the twenty-four volunteers did well.

Based on the results of these tests (trial (a) and (b)), 15 judges were selected for later studies.

Sensorial Study for Comparison of the Salty Taste Enhancer Capacity of Two Dipeptides:

A further study was carried out with 10 of the judges who had successfully passed the previous study to confirm the enhancement effect of the salty taste of the PA dipeptide and compare it with the effect that it had with a peptide was already known to potentiate salty taste, the dipeptide proline-glycine (PG) (US2016374380).

Six dilutions of salt (NaCl) with known concentration (30-80 mM) were prepared (as in example 1a).

In addition, two solutions were prepared that contained 12 mM PA+50 mM NaCl (Sample coded as “C”) and 12 mM PG+50 mM NaCl (Sample coded as “D”).

The solution with the dipeptide PA was prepared as in example 1.

The dipeptide PG was purchased from CASLO and was dissolved in low mineralization water (Bezoya) as well (first it was weighted the dipeptide and dissolved it in the bottled water, then this solution was added to the water solution with NaCl, and, finally, water was added in order to obtain the desired NaCl concentration).

While preparing the solutions, it was remarkable that the dipeptide PG was very sticky, hard to catch and weigh; whereas the dipeptide PA was a powder very easy to weigh and manipulate.

Ten judges were presented with the samples coded as “C” and “D”, which were to be located within the salt-tasting scale of an increasing intensity of salty taste. All judges initially tried the salty scale and knew the correct order of it.

All judges had to taste first the salty taste scale. Next they had to taste the two problem samples (“C” and “D”) and to indicate to what degree of the scale they would locate it according to the intensity of the salty taste.

The judges had to make a descriptive evaluation (taste, aroma, intensity, visual aspect, . . . ) of the two samples (A and B) without knowing the composition.

Results:

TABLE 2
Ranking of the analysed samples in the salty scale:

| Salty scale (NaCl mM) | | | | | |
|---|---|---|---|---|---|
| 30 | 40 | 50 | 60 | 70 | 80 |
| 1 | 2 | 3 | 4 | 5 | 6 |

| | | | | | | | | | | |
|---|---|---|---|---|---|---|---|---|---|---|
| Judge 1 | | | | | | “C” | | “D” | | |
| Judge 2 | | | | “C” | | | | “D” | | |
| Judge 3 | | | | | | “C” | | | | “D” |
| Judge 4 | | | | | | | | “C” | | “D” |
| Judge 5 | | | | “C” | “D” | | | | | |
| Judge 6 | | | | “C” | | “D” | | | | |
| Judge 7 | | | | “D” | | “C” | | | | |
| Judge 8 | | | | | | | “C” | | “D” | |
| Judge 9 | “C” | | “D” | | | | | | | |
| Judge 10 | | “C” | | “D” | | | | | | |

Based on these results, an average considering intermediate values was performed when the judges classified the problem sample between two known salt concentrations (see table 3).

TABLE 3
Given concentrations of salt to the analysed
samples comprising the dipeptides:

| | mM | mM |
|---|---|---|
| | PA | PG |
| Judge 1 | 65 | 75 |
| Judge 2 | 55 | 75 |
| Judge 3 | 65 | 85 |
| Judge 4 | 75 | 85 |
| Judge 5 | 55 | 60 |
| Judge 6 | 55 | 65 |
| Judge 7 | 65 | 55 |
| Judge 8 | 70 | 80 |
| Judge 9 | 40 | 50 |
| Judge 10 | 45 | 55 |
| | 59.0 | 68.5 |

No statistically significant difference was found between the salty taste perception for the dipeptide PA and the dipeptide PG (p=0.097, t-student). Thus, both dipeptides, presented the enhanced the salty taste similarly.

In the descriptive assessment, the dipeptide PG showed more unpleasant aftertaste than the dipeptide PA.

3. Sensorial Evaluation of the Dipeptide PA in Food Material 3.1. Sensorial Evaluation Wherein the Dipeptide PA was Added to a Food Matrix:

The aim of this study was to assess whether the dipeptide PA enhanced salty taste in a food matrix (exemplified with chicken soup broth).

Materials and Methods:

In a commercial chicken broth (which on the label it was described as being low in salt but actually the salt content was 0.26 g/100 mL) (GALLINA BLANCA®) (from now on “commercial chicken broth low in salt”), a salty scale was prepared with increasing concentrations of 1.1 g/L salt (6 solutions, the lowest being the commercial broth 44.5 mM (1) to the highest of 140.3 mM (6)) (see table 4). The salt (NaCl) was the same used in previous experiments.

At the same time, two solutions were prepared with the PA dipeptide (the PA dipeptide of example 1 and 2) at a concentration of 8 mM and 12 mM, the preparation of which was done on the commercial chicken broth low in salt (0.26 g salt/100 mL), by adding 8 mM (0.146 g of PA/100 mL) and 12 mM (0.22 g of PA/100 mL) of the PA dipeptide, respectively.

Judges (selected form the fifteen judges of example 2) were given to evaluate 4 samples: Sample coded as “E”: commercial chicken broth low in salt (44.5 mM) Sample coded as “F”: commercial chicken broth low in salt+8 mM de PA Sample coded as “G”: commercial chicken broth low in salt+12 mM of PA Sample coded as “H”: commercial chicken broth low in salt+salt (140.3 mM)

All samples were maintained at 62° C. until the moment of their sensory evaluation.

The sensory evaluation was carried out in groups of 2-3 judges to be able to be dosed just at the time prior to their evaluation and keep as much as possible the temperature of the broths.

The judges were asked to first try the scale of 1 to 6 (44.5 mM, 63.7 mM, 82.8 mM, 102 mM, 121.1 mM, 140.3 mM) (see table 4) (Scaling method of food samples). Then they tasted the four problems samples (samples “E”, “F”, G″ and “H”) and placed them in the given scale. At the same time, the judges were invited to make any description of the perceived attribute during the evaluation of the samples.

Results:

TABLE 4

| | Salty taste scale | | | | | | | | | | | |
|---|---|---|---|---|---|---|---|---|---|---|---|---|
| | 44.5 | | 63.7 | | 82.8 | | 102 | | 121.1 | | 140.3 | |
| | 1 | 54.1* | 2 | 73.3* | 3 | 92.4* | 4 | 111.55* | 5 | 131* | 6 | 150* |
| Judge 1 | “E” | “F” | | “G” | | | | | | “H” | | |
| Judge 2 | | “E”-“F” | | | | “G” | | | | “H” | | |
| Judge 3 | “E” | | | | | “F” | | “G” | | | “H” | |
| Judge 4 | “E” | “F” | “G” | | | | | | | | “H” | |
| Judge 5 | “E” | | | | “F” | “G” | | | | | “H” | |
| Judge 6 | “E” | | “F” | | | “G” | | | | | “H” | |
| Judge 7 | | “E” | | “F” | | “G” | | | | “H” | | |
| Judge 8 | | | “E” | | “F” | | “G” | | | | “H” | |
| Judge 9 | | | | “E” | | “F” | | “G” | | | | “H” |

*To be able to quantify the values that judges identify between values of the scale, an equitable relationship was made between the points of the scale.

TABLE 5
the salt intensity that the judges attributed to each one of the samples,
taking as a reference the given salt scale (44.5-140.3 mM).

| | | intensity of | | |
|---|---|---|---|---|
| | | perception | | Confidence |
| Sample | | (mM) | deviation | interval |
| “F” | BC [44.5 mM] + | 72.14 | 16.03287 | 10.474613 |
| | 8 mM PA | | | |
| “G” | BC [44.5 mM] + | 92.33 | 16.00617 | 10.4571727 |
| | 12 mM PA | | | |
| “E” | BC [44.5 mM] | 51.96 | 10.4919 | 6.85458311 |
| “H” | BC [140.3 mM] | 138.27 | 6.292412 | 4.11096674 |

“n”, is the number of judges; the confident was 95 for all samples and the number of judges was 9.

Control samples “E” and “H” were correctly identified by most of judges on the scale. It can be observed that all judges evaluate the two samples with the presence of PA (“F” and “G”) with more salt intensity than the control sample “E” (commercial low-salt chicken broth).

Following a 1-way ANOVA+posthoc Tukey test, the panelists perceived significantly different salty taste intensity between the different samples. The results indicated that there were significant differences in the intensity of perception of the 4 samples by the panelists (p<0.001, ANOVA 1 way). Comparisons 2 to 2 made with Tukey's post-hoc indicated that the panelists perceived with an intensity of salty taste different from all the samples (a, b, c, d), presenting the samples containing the dipeptide at 8 and 12 mM more intensity of salty taste than the commercial low-salt broth and less than the stock with more salt-containing content that did not contain the dipeptide. Furthermore, the sample with the PA at 12 mM has a higher salt intensity than the sample with the PA at 8 mM.

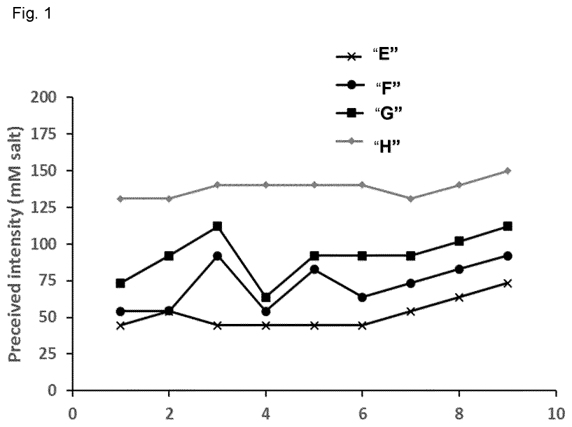

The dipeptide PA enhanced salty taste when it was included in a low salt broth (see FIG. 1), both at 8 mM and at 12 mM, compared to the low salt broth. The PA dipeptide enhanced salty taste more when used at a 12 mM concentration than when used at 8 mM.

Taking in count that a commercial broth with normal salt content was around 0.75 g of salt/100 mL (128 mM salt), the sample coded as “H” exceeded that salt content (which was 0.82 g/100 mL). The reduction of salt in the low salt broth was around 60% in comparison to a commercial broth with normal salt content.

The PA dipeptide when present in a food matrix presented less aftertaste than when it was prepared dissolved in water (described in previous example 1), the intensity of off-flavors/unpleasant flavors was higher in the first trial with bottled water than when the chicken broth was used.

3.2—Sensorial Evaluation Wherein a Food Matrix was Elaborated Comprising the Dipeptide PA

The objective of this test was to evaluate the impact of food processing in the enhance ability of PA to increase the salt flavour, when used as an ingredient in the recipe.

Materials and Methods:

A chicken broth (“low in salt” similar as the one of example 3.1) was prepared using freshly raw materials in the pilot plant of Eurecat. The materials used was as described as follows for preparing 2 L chicken broth:
2 chicken leg quarters
60 g of leek
25 of celery
60 g of carrot
2.6 g of salt
8 mM of PA

Chicken broth procedure at pilot plant: freshly raw material were cleaned and chopped before to introduce into the cooking food. Additionally, the meat and salt were added.

Recipe “A” only contained salt, meanwhile Recipe “B” contained salt+8 mM of PA. Both recipes were cooked during 2.5 hours.

Once finished, broth was filtered and introduced in ISO glass bottles. Samples were kept at 62° C. until sensory evaluation using a water bath at set point of 65° C.

Sensory Evaluation:

Sensory evaluation was carried out with 21 trained judges. It was done in groups of 2-3 people in order to dose the sample and to keep broth temperature. A triangle test was performed. All judges received three samples and the objective was to discard that sample different from the three samples given. Additional comments were requested to judges after the sensory test to get more information. Finally, preference was asked to be answered.

Samples were coded following the codification for triangle test (AAB, ABA, ABB, BAA; BAB; BBA), where “A” was chicken broth low in salt content; and “B”, chicken broth low in salt+dipeptide PA.

Results

The results showed that 19 of 21 judges correctly answered the triangle test, identifying the different sample. Based on the data, the chicken broth with PA showed an increased salt intensity perceived by the judges.

It was confirmed that dipeptide PA used as an ingredient enhanced salt flavor intensity.

Cooking process did not generate off-flavors due to the addition of PA as an ingredient.

The preference shown by the judges between the two chicken broth (chicken broth low in salt and chicken broth low in salt+PA) was higher for chicken broth low in salt+PA.

### CITATION LIST

### Patent Literature

US2016374380
U.S. Pat. No. 8,409,653

### Non Patent Literature

Israr T et al. 2016 Trend in Food Science and Technology 51:98-105.
Schindler A et al. 2011 J. Agric. Food Chem. 59:12578-12588.
Xu J J et al. 2017 Scientific Reports 7:7483.
Regulation (EC) 1924/2006 of the European Parliament and of the Council of 20 Dec. 2006 on Nutrition and Health claims made on foods.
Yagasaki M et al. 2008. Appl. Microbiol. Biotechnol. 81:13-22.

For reasons of completeness, various aspects of the invention are set out in the following numbered clauses:

Clause 1. Use of a dipeptide comprising proline and alanine as a salty taste enhancer in an edible article comprising a salt.

Clause 2. The use of the dipeptide of clause 1, wherein the dipeptide is Proline-Alanine.

Clause 3. The use of the dipeptide of clause 1, wherein the dipeptide is Alanine-Proline.

Clause 4. The use of any one of clauses 1 to 3, wherein the salt is selected from the group consisting of sodium chloride, potassium chloride, calcium chloride and any combination thereof.

Clause 5. The use of clause 4, wherein the salt is sodium chloride.

Clause 6. The use of any one of clauses 1 to 5, wherein the edible article has a reduced content in salt, wherein the reduced content is from 1% to 99% in weight with respect to the conventional edible article.

Clause 7. The use of any one of clauses 1 to 6, wherein the edible article comprises a salt content of equal to or less than 0.120 g of salt per 100 mg or 100 mL of the edible article.

Clause 8. The use of any one of clauses 1 to 7, wherein the dipeptide is added to the edible article in an amount from 0.1% to 15% by weight with respect to the weight of the edible article.

Clause 9. The use of any one of clauses 1 to 8, wherein the edible article is selected from the group consisting of: a seasoning or condiment, a dairy or fat product, a broth, a soup, a savory product, a meat-based product, a seafood-based product, a fish-based product, an egg-based product, a carbohydrate-based product, a baked product, an imitation food products; a pet or animal food, and a beverage.

Clause 10. An edible composition comprising the dipeptide proline-alanine and one or more appropriate edible acceptable excipients or carriers.

Clause 11. The edible composition of clause 10, wherein in addition it comprises at least one other flavor compound.

Clause 12. An edible article comprising the edible composition according to any one of clauses 10 or 11, and a foodstuff base comprising a salt.

Clause 13. The edible article of clause 12, wherein the salt is selected from the group consisting of: sodium chloride, potassium chloride, calcium chloride and any combination thereof.

Clause 14. The edible article of clause 13 wherein the edible article comprises a salt content of equal to or less than 0.120 g of salt per 100 mg or 100 mL of the edible article.

Clause 15. The edible article of any one of clauses 12 to 14 wherein it is selected from the group consisting of: a seasoning or condiment, a dairy or fat product, a broth, a soup, a savory product, a meat-based product, a seafood-based product, a fish-based product, an egg-based product, a carbohydrate-based product, a baked product, an imitation food products; prepared foods; a pet or animal food, or a beverage.

1. Use of a dipeptide comprising proline and alanine as a salty taste enhancer in an edible article comprising a salt.

2. The use of the dipeptide according to claim 1, wherein the dipeptide is Proline-Alanine.

3. The use of the dipeptide according to claim 1, wherein the dipeptide is Alanine-Proline.

4. The use of the dipeptide according to claim 1, wherein the dipeptide is linear.

5. The use according to claim 1, wherein the salt is selected from the group consisting of sodium chloride, potassium chloride, calcium chloride and any combination thereof.

6. The use according to claim 5, wherein the salt is sodium chloride.

7. The use according to claim 1, wherein the edible article has a reduced content in salt, wherein the reduced content is from 1% to 99% in weight with respect to the conventional edible article.

8. The use according to claim 1, wherein the edible article comprises a salt content of equal to or less than 0.120 g of salt per 100 mg or 100 mL of the edible article.

9. The use according to claim 1, wherein the dipeptide is added to the edible article in an amount from 0.05% to 15% by weight with respect to the weight of the edible article.

10. The use according to claim 1, wherein the edible article is selected from the group consisting of: a seasoning or condiment, a dairy or fat product, a broth, a soup, a savory product, a meat-based product, a seafood-based product, a fish-based product, an egg-based product, a carbohydrate-based product, a baked product, an imitation food products; a pet or animal food, and a beverage.

11. An edible composition comprising a salty taste enhancer which is the dipeptide proline-alanine and one or more appropriate edible acceptable excipients or carriers.

12. The edible composition according to claim 11, wherein the dipeptide proline-alanine is linear.

13. The edible composition according to claim 11, wherein in addition it comprises at least one other flavor compound.

14. An edible article comprising the edible composition according to claim 11, and a foodstuff base comprising a salt.

15. The edible article according to claim 14, wherein the salt is selected from the group consisting of: sodium chloride, potassium chloride, calcium chloride and any combination thereof.

16. The edible article according to claim 15 wherein the edible article comprises a salt content of equal to or less than 0.120 g of salt per 100 mg or 100 mL of the edible article.

17. The edible article according to claim 14 wherein it is selected from the group consisting of: a seasoning or condiment, a dairy or fat product, a broth, a soup, a savory product, a meat-based product, a seafood-based product, a fish-based product, an egg-based product, a carbohydrate-based product, a baked product, an imitation food products; prepared foods; a pet or animal food, or a beverage.

18. A method to enhance salty taste of an edible article comprising a salt, wherein the method comprises the addition of the salty taste enhancer dipeptide as defined in claim 1.

19. The method to enhance salty taste according to claim 18, wherein the method comprises the addition of the dipeptide, during the elaboration of the edible article; or, alternatively, after the elaboration of the edible article.

20. The method to enhance salty taste according to claim 18, wherein the method comprises:
a. providing the salty taste enhancer dipeptide salty taste enhancer;
b. selecting at least one food material; and
c. adding the salty taste enhancer dipeptide or, alternatively, the edible composition of step (a), in an amount necessary to maintain saltiness, to the food material of step (b) in order to produce a salty taste low salt or low sodium edible article; and
d. optionally, elaborating the edible article.

21. (canceled)

22. (canceled)
